(19) United States
(12) Patent Application Publication
(10) Pub. No.: US 2009/0008949 A1
(43) Pub. Date: Jan. 8, 2009

(54) Door Handle Apparatus

(75) Inventor: Ching-Tien Lin, Taipei Hsien (TW)

Correspondence Address: SHOEMAKER AND MATTARE, LTD, 10 POST OFFICE ROAD - SUITE 110, SILVER SPRING, MD, 20910, US

(73) Assignee: THASE ENTERPRISE CO., LTD., Taipei Hsien (TW)

(21) Appl. No.: 12/061,929

(22) Filed: Apr. 3, 2008

(30) Foreign Application Priority Data
Jul. 5, 2007 (TW) 096124415

(51) Int. Cl. E05B 3/00

(52) U.S. Cl. 292/336.3

(57) ABSTRACT

The present invention provides a door handle apparatus consisting of a handle, a lock housing, a transmission mechanism, and a locking mechanism. The handle is pivotally engaged with the lock housing. The locking mechanism is engaged with one end of the lock housing and the handle. When the handle is rotated, the locking mechanism makes relative sliding and movement about the handle. The transmission mechanism is engaged with the other end of the lock housing and moves relative to the locking mechanism. The locking mechanism has a burglar free locking piece that prevents the door handle apparatus from being disassembled without being unlocked by a key first. After the door handle is engaged with the transmission mechanism, the door handle is still rotatable and movable via the lock housing.

### BACKGROUND OF THE INVENTION

1. Field of the Invention

The present invention relates to door handle apparatuses, and more particularly, to a door handle apparatus that remains rotatable when in a locked state.

2. Description of the Prior Art

When in a locked state, a conventional door handle is not rotatable as it is fastened. However, when subjecting to an external force or the weight of a heavy object, the door handle is rotated to an extent that its internal parts are damaged. Therefore, a door handle structure that is rotatable when in a locked state has been developed to overcome the drawbacks described above.

Referring to FIGS. 1A, 1B and 1C, FIGS. 1A, 1B and 1C are an exploded diagram and two enlarged views illustrating the structures of a conventional door handle, respectively. The door handle apparatus consists of a handle 2, a connection base 4, a fixing base 11, a rotation base 13, a transmission base 16 and a rotation rack 26. One end of the handle 2 is engaged with the connection base 4, and is fastened by a fastener 5 to transmit force. At the same time, the handle 2 may be engaged with a positioning ring 9, a ring 10 and the fixing base 11 in a sequential order. The connection base 4 is hollow, which allows accommodation of a partition panel 8, the rotation base 13, the transmission base 16, and a spring 23. After the aforesaid parts are added in the connection base 4, the connection base 4 is pressed with a sleeve cylinder 24. A recess 22, which is formed inside the rotation base 13, allows a rotation piece 3 disposed in the door handle 2 to be inserted therein to transmit force. The rotation rack 26 is fastened with one side of the sleeve cylinder 24 by a positioning cylinder 27. The elasticity of the spring 23 causes the handle 2 and the connection base 4 to rotate idly when the handle 2 is rotated, disabling the rotation rack 26 to rotate to transmit force to one side of a door lock of an escape door, thus damages to the door handle caused by external forces applied thereupon in a lockedstate are prevented.

Moreover, a torque spring 28 is engaged with one side of the positioning cylinder 27, and a fixing piece 29 is then pressed on the positioning cylinder 27. A sheath 30 is engaged with one side of the fixing base 11 and covered by a cover plate 32. Then, the protective sheath 30 is fixed to a plurality of lock bolts 12 by screwing into the fixing base 11 with a plurality of screws 41. The cover plate 32 is formed with a screw hole 31 for screwing into to one side of the door lock of an escape door, such that the inner parts of the door lock can be protected from damages.

Furthermore, after the rotation rack 26 is connected with the door lock of an escape door, when a key 1 rotates to a specific angel, the rotation piece 3 transmits force to rotate the rotation base 13. Push action caused by friction occurs between a V-shaped cutting groove 14 of the rotation base 13 and a V-shaped bump 20 of the transmission base 16. A pair of protruding ears 17, 19 formed on both sides of the transmission base 16 are disposed in a pair of guiding slots 6, 7 formed on the connection base 4, respectively. This allows the transmission base 16 to move horizontally toward one side, until a top end 21 of the V-shaped bump 20 is fastened to a pair of slots 130, 131 formed in the rotation base 13. Simultaneously, the spring 23, which is compressed to one side of the connection base 16, enables a groove 18 formed in the transmission base 16 and a threshold block 25 of the rotation rack 26 to be engaged to transmit force, thereby allowing the transmission base 16 and the rotation rack 25 to rotate by the force transmitted through the connection base 4.

However, conventional door handle apparatuses use an elastic spring to transmit force for connecting or disconnecting a locking structure and a rotating structure. After a long period of use of the apparatuses, problems like elastic fatigue occurs on the spring, affecting the transmission relationship among the parts and may eventually cause malfunction.

Accordingly, it is important to develop a door handle apparatus that can remedy the drawbacks of prior arts and offers easiness and convenience in use.

### SUMMARY OF INVENTION

In light of the shortcomings of the above prior art, it is an object of the present invention to provide a door handle apparatus that remains rotatable when in a lockedstate.

It is another object of the present invention to provide a door handle apparatus that can only be disassembled when in an unlocked state.

In order to achieve the above and other objects, the present invention provides a door handle apparatus having a transmission mechanism slidably disposed in a spiral groove of a locking mechanism to achieve conversion of the transmission relationship therebetween by a rigid structure. Additionally, the locking mechanism has a burglarproof locking piece to keep the door handle apparatus from being disassembled when in an unlocked state. In other words, a user needs to unlock the door handle apparatus with a key before it being disassembled from the door.

The door handle apparatus of the present invention comprises a handle having a pivotal connecting portion and an action portion, the pivotal connecting portion is connected with the action portion and has a through hole penetrating therethrough; a lock housing having a first housing assembly and a corresponding second housing assembly, wherein the handle is pivotally engaged with the first housing assembly, and the center of the second housing assembly is formed with an opening; a locking mechanism comprising at least a core lock, a sleeve cylinder and a locking piece, wherein the core lock is disposed and fastened in the through hole of the handle, the sleeve cylinder, which has a plurality of guiding grooves, is engaged with both the core lock and the first housing assembly and fastened to the core lock, and the locking piece is slidably engaged with the sleeve cylinder and formed with an open slot for moving, via an inner brim, relative to the core lock; and a transmission mechanism having a first transmission assembly slidably engaged with the sleeve cylinder and a second transmission assembly rotatably engaged with the second housing assembly, wherein one end of the first transmission assembly is engaged with the sleeve cylinder and transmits force to move relative to the core lock, a spiral groove and a limiting lever are disposed at positions close to where the core lock is located, wherein the limiting lever is disposed in the spiral groove, and passes through the sleeve cylinder to secure the first transmission assembly in position, and one end of the second transmission assembly passes through the through hole to protrude from the second housing assembly, such that the second transmission assembly transmits force to move relative to the first transmission assembly by engaging the first transmission assembly with the second transmission assembly.

Preferably, the pivotal connecting portion has a limiting groove connected with the through hole, and the core lock has a limiting bump corresponding to the limiting groove. The core lock, which is engaged with the pivotal connecting portion, enables the limiting bump to wedge in the limiting groove and makes the core lock move when a user rotates the handle. The core lock, when being rotated, pushes the open slot to move the locking piece, and rotates the transmission mechanism at the same time to move axially about the sheath cylinder by the relative movement of the limiting lever and the spiral groove.

The first housing assembly further comprises an upper lid, a handle base engaged with the upper lid; and a reset ring movably engaged with the handle base and having a plurality of bumps disposed on the inner brim thereof, and the bumps correspond to the guiding grooves, wherein the bumps wedge in the guiding grooves when the sleeve cylinder is assembled into the first housing assembly, allowing the sleeve cylinder to transmit force and move relative to the reset ring. The reset ring has an elastic spring connecting the reset ring with the handle base, enabling the reset ring to spring back to its original position by the elasticity of the spring after being rotated by an external force.

The first transmission assembly further comprises an upper-lock sheath having a gourd opening for correspondingly coupling to the core lock, wherein the spiral groove of the first transmission assembly is engaged with the upper-lock sheath; and a sliding block with one end being connected with the upper lock sheath the other end being connected with the second transmission assembly, and transmits force to move it, when the first transmission assembly moves.

The second transmission assembly comprises a shaft penetrating the through hole of the second housing assembly; and a fastening sheath with one end engaged with the shaft and the other end moving relative to the sliding block, wherein at least an elastic positioning member abutting against an inner side of the second housing assembly is engaged with the fastening sheath at positions close to the second housing assembly, and at least a positioning hole corresponding to the moving trajectory of the elastic positioning member is formed on the inner side of the second housing assembly, when the fastening sheath is rotated to move the elastic positioning member to the positioning hole, the elastic positioning member wedges in the positioning hole, thereby holding the second transmission assembly in a predetermined position. The second housing assembly is formed with a plurality of positioning holes on the outer brim, and is connected with the first housing assembly by a plurality of screws.

Compared with conventional door handle apparatus using an elastic spring to transmit force, the present invention provides a door handle apparatus with a rigid structure to convert the transmission status of connection and disconnection, and eliminating the problem like elastic fatigue associated with prior arts. Additionally, the locking mechanism of the present invention has a burglarproof locking piece that prevents the door handle apparatus from being disassembled without being unlocked by a key first. Thus, the present invention has advantages over conventional techniques and has high industrial applicability.

In conclusion, the door handle apparatus of the present invention can overcome the problems of prior arts, to allow for broader applications and effective reduction in production costs.

### BRIEF DESCRIPTION OF DRAWINGS

FIG. 1A shows an exploded diagram illustrating the structure of a conventional door handle apparatus;

FIG. 1B shows an enlarged view illustrating the rotation base of a conventional door handle apparatus;

FIG. 1C shows an enlarged view illustrating the transmission base of a conventional door handle apparatus;

FIG. 2 shows an exploded diagram illustrating the door handle apparatus according to the present invention;

FIG. 3 shows a cross-sectional diagram illustrating the assemblage of the door handle apparatus with a locking mechanism according to the present invention;

FIG. 4A shows a cross-sectional diagram illustrating the assemblage of the handle, the locking mechanism, and the transmission mechanism not in a transmission state according to the present invention;

FIG. 4B shows a cross-sectional diagram illustrating the assembly of the handle, the locking mechanism and the transmission mechanism in a transmission state according to the present invention;

FIG. 5A shows a cross-sectional diagram illustrating an assembled door handle apparatus according to the present invention; and

FIG. 5B shows a cross-sectional diagram illustrating the assembled door handle apparatus with its handle rotated according to the present invention.

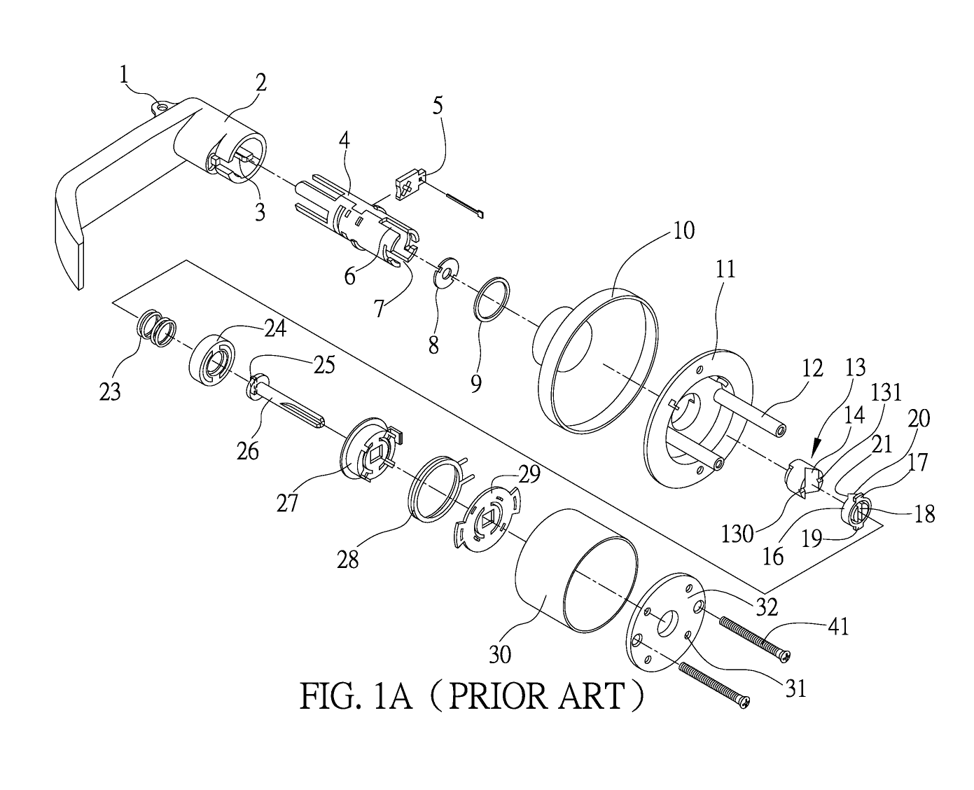

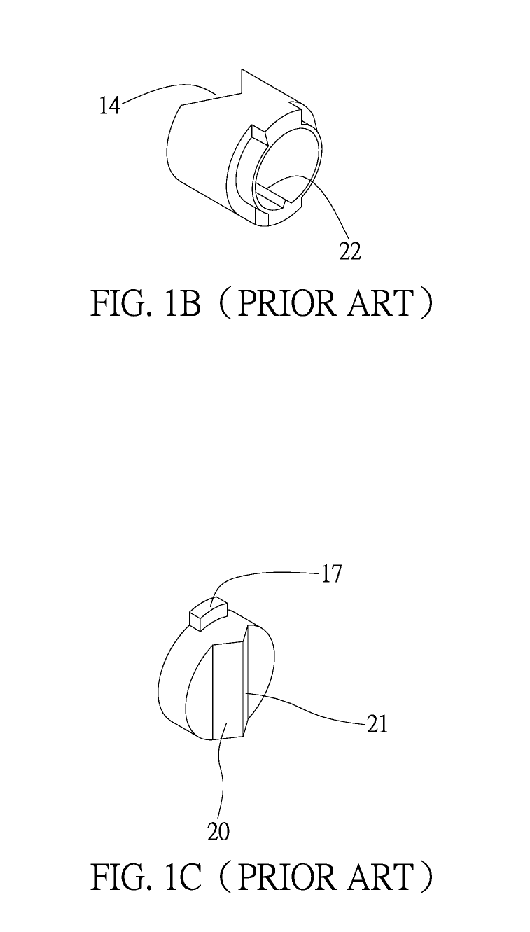

### DETAILED DESCRIPTION OF THE PREFERRED EMBODIMENTS

The present invention is described in the following using preferred embodiments, so that one skilled in the art can readily conceive other advantages and effects of the present invention.

The embodiments of the present invention are illustrated with reference to the following figures. It should be noted that the appended drawings are simplified figures illustrating the basic concept of the present invention, and the elements shown in the drawings are only exemplary and not depicted according to the actual types, numbers, or proportions of the elements, such drawings are intended to be illustrative but not limiting the scope of the invention.

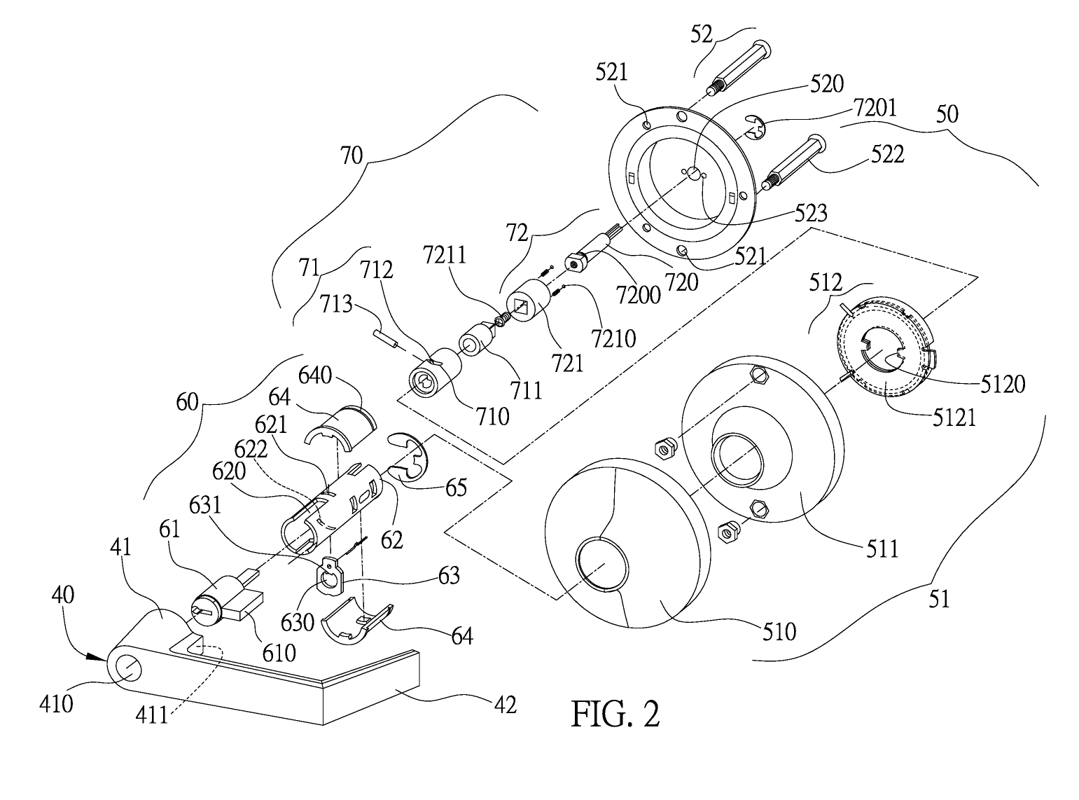

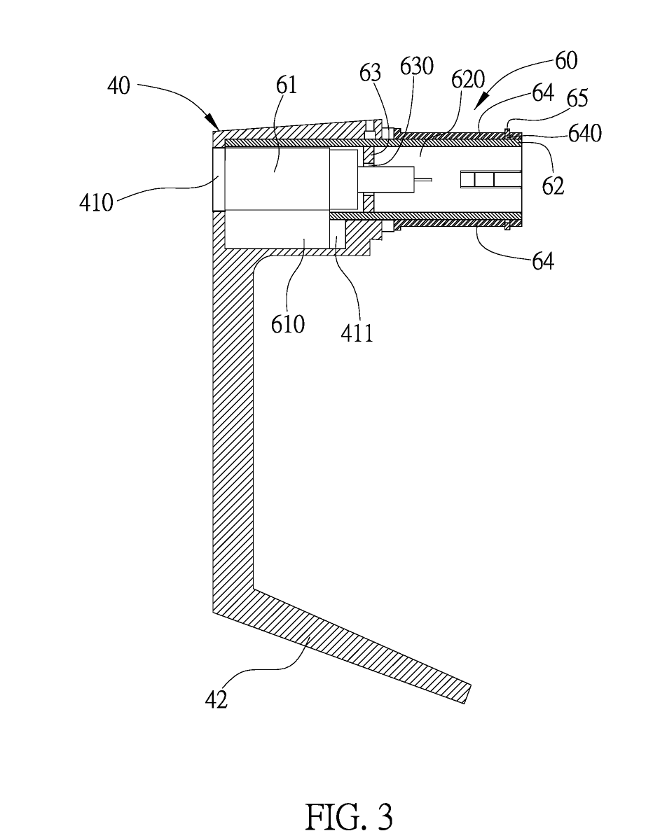

Referring to FIG. 2, FIG. 2 is an exploded diagram illustrating the door handle apparatus according to the present invention. As shown in the figure, the door handle apparatus comprises a handle 40, a lock housing 50, a locking mechanism 60 and a transmission mechanism 70. The handle 40 has a pivotal connecting portion 41 and an action portion 42 connected with the pivotal connecting portion 41, wherein the pivotal connecting portion 41 has a through hole 410 and a limiting groove 411 inside connected with the through hole 410. The lock housing 50 has a first housing assembly 51 and a corresponding second housing assembly 52, wherein the handle 40 is pivotally connected with the first housing assembly 51, and the second housing assembly 52 has an opening 520 in the center and a plurality of fixing holes 521 on the periphery. The locking mechanism 60 has at least a core lock 61, a sleeve cylinder 62, and a locking piece 63, wherein the core lock 61 is disposed and fastened in the through hole 410 of the handle 40, and has a limiting bump 610 corresponding to the limiting groove 411. When the core lock 61 is engaged with the pivotal connecting portion 41, the limiting bump 610 wedges in the limiting groove 411, so as to allow the handle 40 to be rotated to simultaneously transmit force to the core lock 61. The sleeve cylinder 62 has a plurality of guiding grooves 620 engaged with the core lock 61, and are engaged with the first housing assembly 51, wherein the limiting bump 610 of the core lock 61 wedges in one of the guiding grooves 620 of the sleeve sheath 62, so as to enable the core lock 61 to move along with rotation of the handle 40 to transmit force to move relative to the sleeve sheath 62. The locking piece 63 is slidably engaged with the sleeve cylinder 62, and has an open slot 630 for connecting with the core lock 61 and transmitting force to move, via an inner brim thereof, relative the core lock 61. The transmission mechanism 70 has a first transmission assembly 71 slidably engaged with the sleeve cylinder 62 and a second transmission assembly 72 rotatably engaged with the second housing assembly 52, wherein one end of the first transmission assembly 71 is engaged with the sleeve cylinder 62, and is connected with the core lock 61. A spiral groove 712 and a limiting lever 713 are disposed at positions close to where the core lock 61 is located, wherein the limiting lever 713 is disposed in the spiral groove 712 and passes through the sleeve cylinder 62 to secure the first transmission assembly 71 in position, while one end of the second transmission assembly 72 passes through the through hole 520 to penetrate from the second housing assembly 52, such that the second transmission assembly transmits force to move relative to the first transmission assembly by moving the first transmission assembly 71 and engaging it with the second transmission assembly 72.

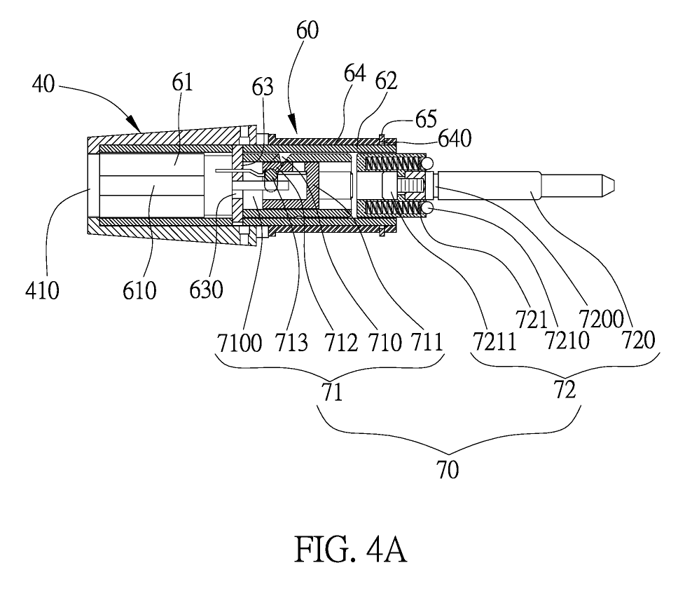

Referring to FIG. 3, FIG. 3 is a cross-sectional diagram illustrating the assembly of the door handle apparatus with a locking mechanism according to the present invention. As shown in the figure, the sleeve cylinder 62 has a pair of through slots 621, 622 corresponding in dimensions to both ends of the locking piece 63 to receive the locking piece 63 therein. Moreover, the sleeve cylinder 62 is further engaged with two protecting pieces 64, wherein one end of the sleeve cylinder 62 has a fixing slot 640 having a C-shaped ring 65 coupled thereto for allowing the two protecting pieces 64 to be engaged with the sleeve cylinder 62. Furthermore, the C-shaped ring 65 has an additional function as a retainer, which is described later. When the core lock 61 is rotated, the inner brim of the locking piece 63 has a bump 631 that pushes the slot 630 to move the locking piece 63; and when the core lock 61 is connected with the bump 631, the bump 631 limits the movement of the locking piece 63 in the cylinder 62. In other words, the locking piece 63 is locked and immovable when the core lock 61 is in a locked state. Since the locking piece 63 is a pivotal action member in a disassembled door handle apparatus, the door handle apparatus cannot be disassembled without a unlocking with a key.

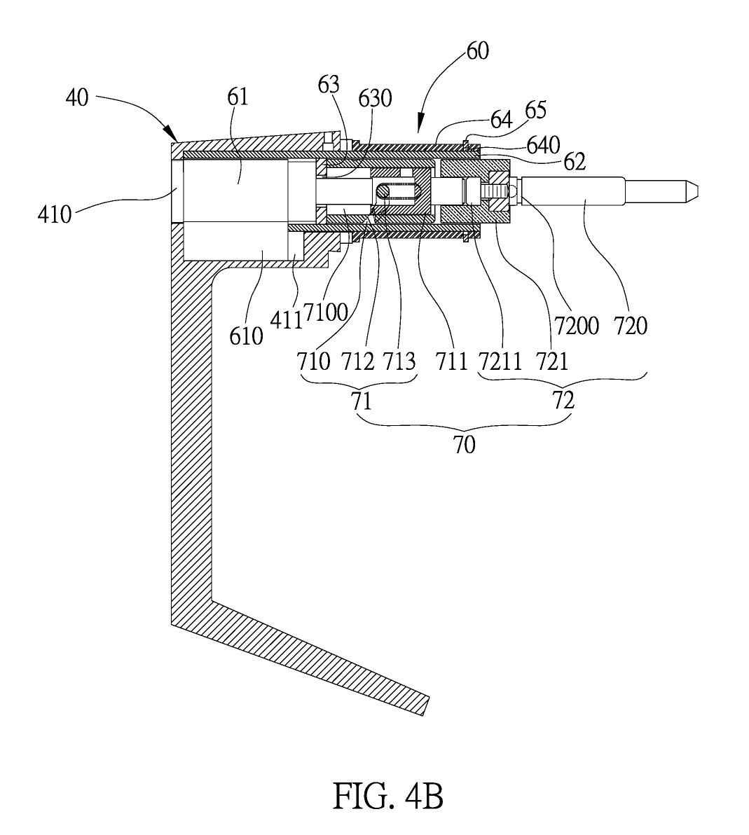

Referring to FIGS. 4A and 4B, FIG. 4A is a cross-sectional diagram illustrating the assemblage of the handle, the locking mechanism, and the transmission mechanism not in a transmission state, and FIG. 4B is a cross-sectional diagram illustrating the assemblage of the handle, the locking mechanism and the transmission mechanism in a transmission state moving relative to one another. As shown in the figures, the first transmission assembly 71 of the transmission mechanism 70 further comprises an upper-lock sheath 710 and a sliding block 711. The upper-lock sheath 710 has a gourd opening 7100 for correspondingly coupling to the core lock 61, wherein a spiral groove 712 of the first transmission assembly 71 is engaged with the upper-lock sheath 710. One end of the sliding block 711 is connected with the upper lock sheath 710, while the other end is connected with the second transmission assembly 72 and transmits force to move it, when the first transmission assembly 71 is moved.

The second transmission assembly 72 comprises a shaft 720 and a fastening sheath 721. The shaft 720 passes through to be disposed on the through hole 520 of the second housing assembly 52. One end of the fastening sheath 721 disposed on the shaft 720, and enables the sliding block 711 to move relative to the fastening sheath 721 when the sliding block 711 is coupled to the fastening sheath 721, that is, the door handle apparatus is in an unlocked state.

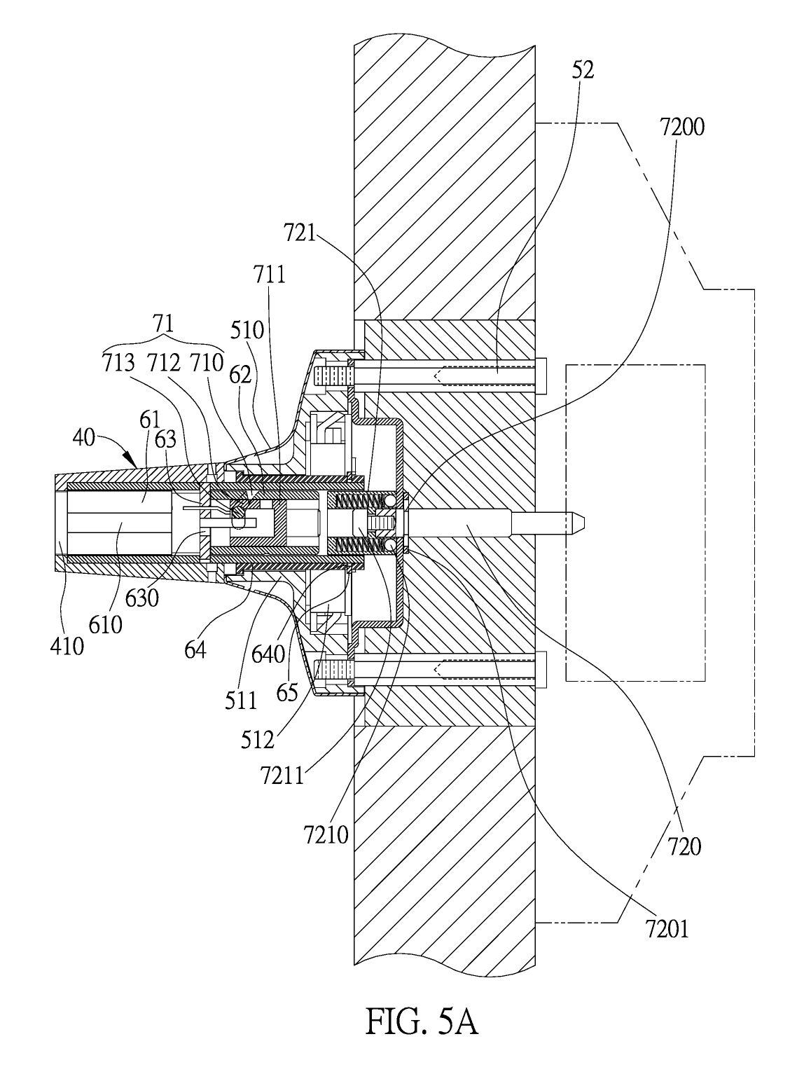

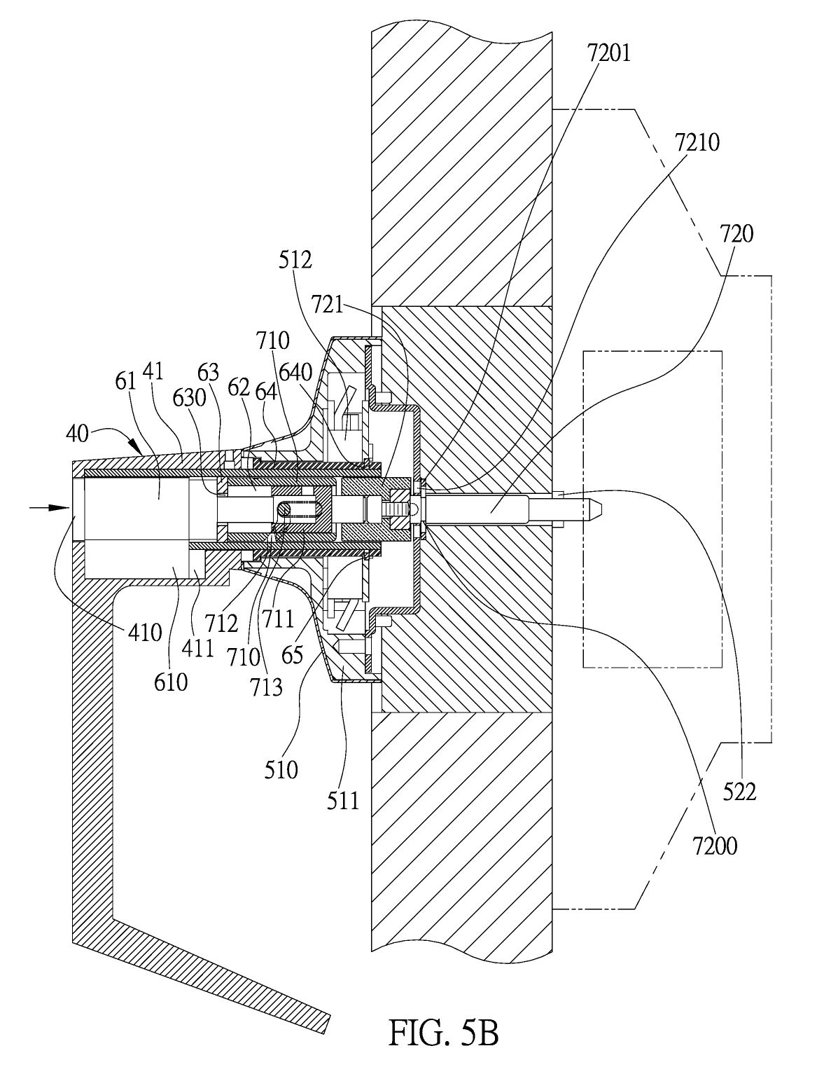

Referring to FIGS. 5A and 5B, FIG. 5A is a cross-sectional diagram illustrating an assembled the door handle apparatus, and FIG. 5B is a cross-sectional diagram illustrating an assembled door handle apparatus with its handle rotated. As shown in the figures, the first housing assembly 51 further comprises an upper lid 510, a handle base 511, and a reset ring 512. The handle base 511 is engaged with the upper lid 510. The reset ring 512 is movably engaged with the handle base 511, and has a plurality of bumps 5120 disposed on the inner brim. The bumps 5120 wedge in the guiding grooves 620, wherein the bumps 5120 wedge in the guiding grooves 620 when the sleeve cylinder 62 is assembled into the first housing assembly 51, so as to allow the sleeve cylinder 62 to transmit force and move relative to the reset ring 512. The reset ring 512 has an elastic spring 5121 connecting the reset ring 512 with the handle base 511. The reset ring 512, after being rotated by an external force, springs back to its original position by the elasticity of the spring 5121. In other words, the handle 40, after being rotated, is reset to return to its original position by the relative movement in a transmission relationship among the core lock 61, the sleeve sheath 62 and the reset ring 512. Moreover, the second housing assembly 52, is connected with the first housing assembly 51 with a plurality of screws 522, after passing through the fixing hole 521. In addition, the fastening sheath 721 is locked to the shaft 720 with a screw 7211. After passing through the through hole 520 of the second housing assembly 52, the shaft 720 is coupled to a fixing hole 7200 of the shaft 720 by a C-shaped ring 7201, after passing through the hole 520 of the second housing assembly 52, to allow the shaft 720 to be rotatably engaged with the second transmission assembly 52.

Furthermore, a pair of elastic positioning members 7210 abutting against an inner side of the second housing assembly 52 is engaged with the fastening sheath 721 at positions close to the second housing assembly 52, and a pair of positioning holes 523 corresponding to the moving trajectory of the elastic positioning member are formed on the inner side of the second housing assembly 52. When the fastening sheath 721 is rotated to move the elastic positioning members 7210 to the positioning holes 523, the elastic positioning members 7210 are fastened to positioning holes 523, thereby holding the second transmission assembly 72 in a predetermined position.

Compared with conventional door handle apparatuses using an elastic spring for transmission, the present invention employs a rigid structure to achieve conversion of the transmission status of connection and disconnection, such that the problem of elastic fatigue is eliminated. Additionally, the locking mechanism of the present invention has a burglarproof locking piece that prevents the door handle from being disassembled from a predetermined position without being unlocked with a key first. Therefore, the door handle apparatus of the present invention can sufficiently overcome the drawbacks of the conventional techniques, and has high industrial applicability.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. A door handle apparatus, comprising:
a handle having a pivotal connecting portion and an action portion, the pivotal connecting portion being connected with the action portion and having a through hole penetrating therethrough;
a lock housing having a first housing assembly and a corresponding second housing assembly, the handle being pivotally engaged with the first housing assembly, and the second housing assembly having an opening in its center;
a locking mechanism having at least a core lock, a sleeve cylinder and a locking piece, the core lock being disposed and fastened in the through hole of the handle, the sleeve cylinder being engaged with the core lock and the first housing assembly and fastened to the core lock, the locking piece being slidably engaged with the sleeve cylinder and having an open slot for moving relative to the core lock via an inner brim thereof, and the sleeve cylinder having a plurality of guiding grooves; and
a transmission mechanism having a first transmission assembly slidably engaged with the sleeve cylinder and a second transmission assembly rotatably engaged with the second housing assembly, wherein one end of the first transmission assembly being engaged with the sleeve cylinder and transmitting force to move relative to the core lock, a spiral groove and a limiting lever being disposed at positions close to where the core lock is located, the limiting lever being disposed in the spiral groove and passes through the sleeve cylinder to secure the first transmission assembly in position, and one end of the second transmission assembly passing through the through hole to protrude from the second housing assembly, such that the second transmission assembly transmits force to move relative to the first transmission assembly by the engaging the first transmission assembly with the second transmission assembly.

2. The door handle apparatus of claim 1, wherein the pivotal connecting portion has a limiting groove connected with the through hole, the core lock has a limiting bump corresponding to the limiting groove, and by the core lock engaged with the pivotal connecting portion, the limiting bump wedges in the limiting groove and makes the core lock move when the handle is rotated.

3. The door handle apparatus of claim 1, wherein the core lock is rotated to push the open slot to move the locking piece, and the transmission mechanism is simultaneously rotated and moves axially along the sheath cylinder by the relative movement of the limiting lever and the spiral groove.

4. The door handle apparatus of claim 1, wherein the first housing assembly comprises
an upper lid;
a handle base engaged with the upper lid; and
a reset ring movable engaged with the handle base and having a plurality of bumps disposed on the inner brim thereof, the bumps corresponding to the guiding grooves, wherein the bumps wedge in the guiding grooves when the sleeve cylinder is assembled into the first housing assembly, allowing the sleeve cylinder to transmit force and move relative to the reset ring.

5. The door handle apparatus of claim 4, wherein the reset ring has an elastic spring connecting the reset ring with the handle base, enabling the reset ring to spring back to its original position by the elasticity of the spring after being rotated by an external force.

6. The door handle apparatus of claim 1, wherein the first transmission assembly comprises
an upper-lock sheath having a gourd opening correspondingly coupling to the core lock, and the spiral groove of the first transmission assembly being engaged with the upper lock sheath; and
a sliding block with one end being connected with the upper lock sheath, the other end being connected with the sleeve cylinder, and transmitting force to the second transmission assembly when the first transmission assembly moves.

7. The door handle apparatus of claim 1, wherein the second transmission assembly comprises
a shaft penetrating the through hole of the second housing assembly; and
a fastening sheath with one end engaging with the shaft and the other end moving relative to the sliding block.

8. The door handle apparatus of claim 7, wherein at least an elastic positioning member abutting against an inner side of the second housing is engaged with the fastening sheath at positions close to the second housing assembly, and at least a positioning hole corresponding to the moving trajectory of the at least one elastic positioning member is formed on the inner side of the second housing assembly, and when the fastening sheath is rotated to move the at least an elastic positioning member to the at least a positioning hole, the at least an elastic positioning member wedges in the at least a positioning hole, thereby holding the second transmission assembly in a predetermined position.

9. The door handle apparatus of claim 1, wherein the second housing assembly has a plurality of positioning holes on an outer brim thereof and is connected with the first housing assembly with a plurality of screws.
